(19) United States
(12) Patent Application Publication
(10) Pub. No.: US 2016/0036853 A1
(43) Pub. Date: Feb. 4, 2016

(54) STORAGE MEDIUM STORING PROGRAM FOR LOGIN ALERTS, AND METHOD AND SYSTEM THEREOF

(71) Applicant: DeNA Co., Ltd., Tokyo (JP)

(72) Inventors: Toshiharu SUGIYAMA, Tokyo (JP); Masaaki YOSHIKAWA, Tokyo (JP)

(21) Appl. No.: 14/806,003

(22) Filed: Jul. 22, 2015

(30) Foreign Application Priority Data
Jul. 30, 2014 (JP) 2014-154433

(51) Int. Cl. H04L 29/06; H04L 29/08; G06F 9/54

(52) U.S. Cl. CPC H04L 63/1483; G06F 9/542; H04L 67/02; H04L 63/08

(57) ABSTRACT

To prevent logins to illegitimate sites such as phishing sites, a terminal device according to an embodiment stores authentication information used for login to a destination site in a storage (the authentication information storage area) in association with the site, and determines whether authentication information corresponding to the authentication information input for login to the destination site is stored in the storage in association with a site different from the destination site. The terminal device performs a predetermined alert process in response to the determination that the corresponding authentication information is stored in association with the different site.

### CROSS-REFERENCE TO RELATED APPLICATIONS

This application is based on and claims the benefit of priority from Japanese Patent Application Serial No. 2014-154433 (filed on Jul. 30, 2014), the contents of which are hereby incorporated by reference in their entirety

### TECHNICAL FIELD

The present disclosure relates to a computer-readable storage medium storing a program for login alerts, and a method and a system thereof. More specifically, the disclosure relates to a storage medium storing a program for raising alerts over logins to illegitimate sites, and a method and a system thereof.

### BACKGROUND

There has been a problem of phishing sites where third parties create fake websites that look like the legitimate ones. Users are guided to the phishing sites and directed to enter their authentication information such as user IDs and passwords, and sensitive information such as personal information, and the third parties fraudulently acquire such information. To prevent damages caused by such phishing sites, International Publication No, 2006/087908 discloses a method to prevent access to the phishing sites. According to the method, a list of URLs of phishing sites is stored and a URL of destination content is compared with the URLs in the list. If the URL of the destination content matches any of the URLs of the phishing sites, access to the content is inhibited.

According to the disclosed method, information about websites which are likely or recognized as phishing sites is needed to be gathered in order to construct the list of URLs of the phishing sites. However, such information become available after damages of the phishing sites has been spread. In other words, it is difficult to prevent the spread of damages rendered by phishing sites at an early stage with the method using the URL list of the phishing sites. Moreover, due to the recent wide use of smartphones and Internet services using applications executed on the smartphones, the above-mentioned sensitive information can be transmitted through various applications other than web browsers. Accordingly, a spreading pace of damage caused by phishing sites tends to be increasing. Therefore, it is desirable to provide a mechanism in which accesses to phishing sites are adequately prevented even before the site is recognized as a phishing site.

### SUMMARY

One object of an embodiment of the disclosure is to prevent logins to illegitimate sites such as phishing sites. Other objects of the embodiments of the present disclosure will be apparent with reference to the entire description in this specification.

A computer-readable storage medium according to one embodiment stores a program for raising alert over login to illegitimate sites. In response to execution of the program on a computer accessible to a storage device that stores, for each of one or more sites, authentication information used for login to the site in association with the site, the computer is caused to perform: determining whether authentication information corresponding to the authentication information input for login to a destination site is stored in the storage device in association with a site different from the destination site; and performing a predetermined alert process in response to determination that the corresponding authentication information is stored in association with the different site.

A method of raising alert over login to illegitimate sites by one or more computers according to one embodiment includes: storing authentication information for each of one or more sites in a storage device in association with the site; determining whether authentication information corresponding to authentication information input for login to a destination site is stored in the storage device in association with a site different from the destination site; and performing a predetermined alert process in response to determination that the corresponding authentication information is stored in association with the different site.

A system for raising alert over login to illegitimate sites according to one embodiment includes: a storage device storing authentication information for each of one or more sites in a storage device in association with the site, and one or more computer processors. In response to execution of a predetermined instruction, the one or more computer processor performs: determining whether authentication information corresponding to authentication information input for login to a destination site is stored in the storage device in association with a site different from the destination site, and performing a predetermined alert process in response to determination that the corresponding authentication information is stored in association with the different site.

According to various embodiments of the disclosure, it is possible to prevent logins to illegitimate sites such as phishing sites.

### BRIEF DESCRIPTION OF THE DRAWINGS

FIG. 1 is a block diagram schematically illustrating a configuration of a network system including a terminal device 10 according to an embodiment of the present disclosure.

FIG. 2 is a block diagram illustrating functions (module configuration) of a login alert program 40 according to an embodiment.

FIG. 3 illustrates an example of an authentication information management screen 50 according to an embodiment.

FIG. 4 illustrates an example of an authentication information register screen 60 according to an embodiment,

FIG. 5 illustrates specific examples of the authentication information for each site stored in an authentication information storage area 45 according to an embodiment.

FIG. 6 is a flow diagram showing an example of a login alert process according to an embodiment.

FIG. 7 illustrates an example of a login alert screen 70 according to an embodiment.

### DESCRIPTION OF THE PREFERRED EMBODIMENTS

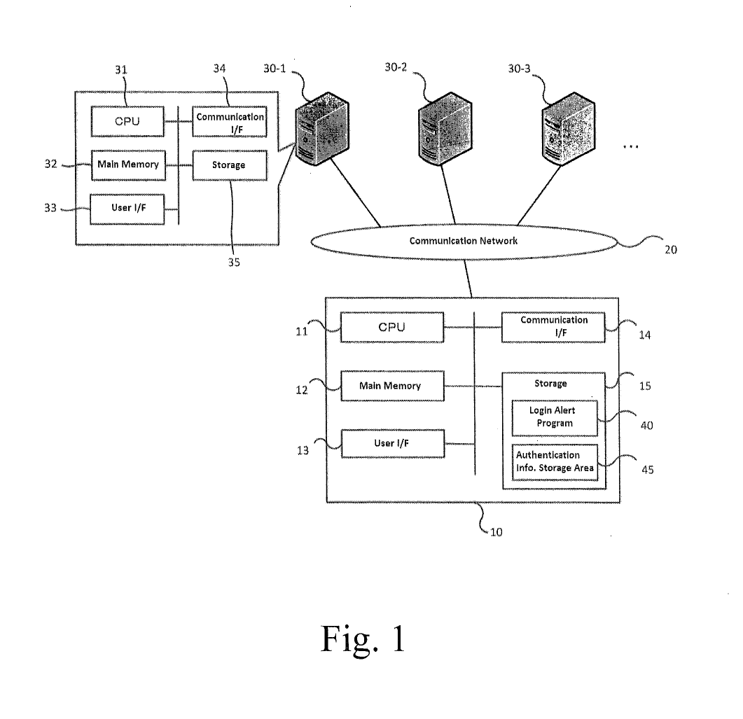

FIG. 1 is a block diagram schematically illustrating a configuration of a network system including a terminal device 10 according to an embodiment of the present disclosure. Referring to FIG. 1, the terminal device may be communicatively connected to more than one server 30 such as servers 30-1, 30-2, 30-3 via a communication network 20 such as Internet. The terminal device 10 may serve as a system that alerts logins to sites other than legitimate sites.

As illustrated in FIG. 1, the terminal device 10 may be configured as a common computer device and may include a central processing unit (CPU) (computer processor) 11, a main memory 12, a user interface (I/F) 13, a communication I/F 14, and a storage 15, and these components may be electrically connected to one another via a bus. The terminal device 10 according to an embodiment may include a personal computer, a smartphone, a tablet terminal, a wearable device, a game-dedicated terminal, and the like.

The CPU 11 may load an operating system and various programs into the main memory 12 from the storage 15, and may execute commands included in the loaded programs. The main memory 12 may be used to store a program to be executed by the CPU 11, and may be formed of, for example, a dynamic random access memory (DRAM) or the like.

The user I/F 13 may include, for example, an information input device such as a touch panel, a keyboard, a button, and a mouse for accepting an input from a user, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the server 30 via the communication network 20.

The storage 15 may comprise, for example, a magnetic disk drive or a flash memory and store various programs such as an operating system. The storage 15 may also store various applications received from the serve 30 and the like.

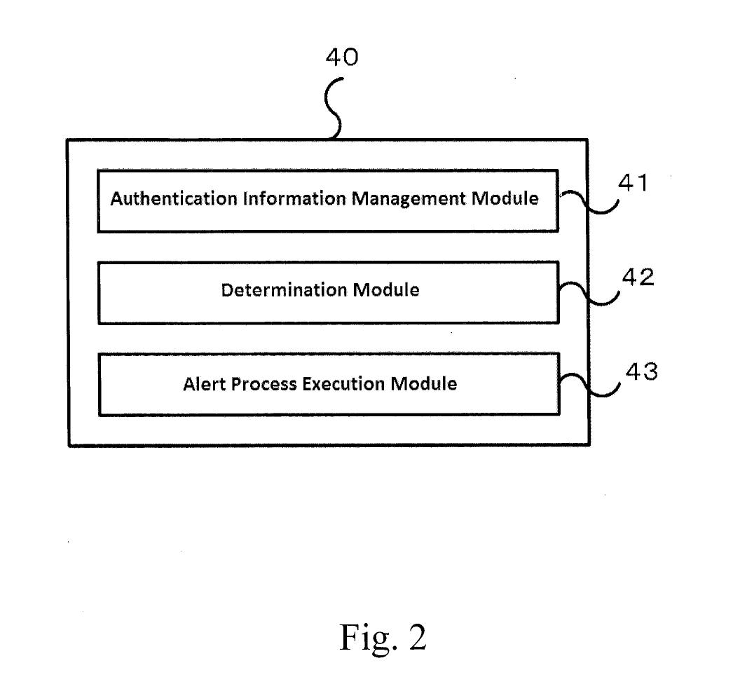

In the storage 15 of the terminal device 10 according to an embodiment, a login alert program 40 according to an embodiment of the disclosure may be stored (installed) in order to alert logins to illegitimate sites as illustrated in FIG. 1. FIG. 2 is a block diagram illustrating functions (module configuration) of a login alert program 40 according to an embodiment. Referring to FIG. 2, the login alert program 40 according to the embodiment may include an authentication information management module 41 configured to manage (for example, display, register, correct, delete or the like) authentication information for login to sites. The authentication information may be stored in association with the sites. The login alert program 40 may further include a determination module 42 configured to determine whether authentication information corresponding to authentication information input by a user to log in to an intended site is stored in association with a different site from the intended site in an authentication information storage area 45, which will be hereunder described in detail. The login alert program 40 may further include an alert process execution module 43 configured to execute a prescribed alert process in response to the determination that the corresponding authentication information is stored in association with a different site. When the login alert program 40 having the above-described functions is run, the terminal device 10 according to the embodiment may perform the processes corresponding to the modules 41, 42, 43 and the functions corresponding to the modules 41, 42, 43 are realized.

The storage 15 of the terminal device 10 according to the embodiment may further include the authentication information storage area 45 that stores authentication information for each of the sites managed by the function of the authentication information management module 41 of the above-described login alert program 40 shown in FIG. 1. The authentication information storage area 45 according to an embodiment may be configured as an area dedicate to the login alert program 40 such that only the login alert program 40 can access to the area but other applications cannot access thereto. Details of the information stored in the authentication information storage area 45 will be hereunder described

The server 30 according to one embodiment may be communicatively connected with the terminal device 10 via the communication network 20. Various contents such as on-line games and various Internet services such as electronic commerce, on-line banking, and social networking services may be provided to a user of the terminal device 10. As illustrated in FIG. 1, the server 30 may be configured as a common computer device and may include a central processing unit (CPU) (computer processor) 31, a main memory 32, a user interface (I/F) 33, a communication I/F 34, and a storage 35, and these components may be electrically connected to one another via a bus.

The CPU 31 may load an operating system and various programs into the main memory 32 from the storage 35, and may execute commands included in the loaded programs. The main memory 32 may be used to store a program to be executed by the CPU 31, and may be formed of, for example, a dynamic random access memory (DRAM) or the like. The server 30 according to an embodiment may be configured from computer devices that have the above-described hardware configurations.

The user I/F 33 may include, for example, an information input device such as a keyboard and a mouse for accepting an input from an operator, and an information output device such as a liquid crystal display for outputting calculation results of the CPU 31. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the terminals 10 via the communication network 20.

The storage 35 may be formed of, for example, a magnetic disk drive and store various programs such as a control program for controlling the provision of various services. The storage 35 may also store various data used in the provision of various services. The various data that may be stored in the storage 35 may also be stored on a database server communicatively connected to the server 30 and physically separate from the server 30.

In an embodiment, the server 30 may also function as a web server for managing a web site including a plurality of hierarchical web pages and may provide the terminal device 10 with various above-mentioned Internet services through the web site. The storage 35 may also store the HTML data corresponding to the web page. Additionally, the HTML data may include programs written in script languages such as JavaScript™.

In an embodiment, the serer 30 may provide a user of the terminal device 10 with various Internet services through applications other than a web browser executed on the terminal device 10. The storage 35 may also store such applications. The game application programs may be created in, for example, programing languages such as Objective-C™ and Java™. The application stored on the storage 35 may be delivered to the terminal device 10 in response to a delivery request. The terminal device 10 may download such applications from a server (a server providing application markets) other than the server 30.

In the network system having the above-described configuration, a user of the terminal device 10 may be able to use various Internet services provided by the server 30 through web browsers or applications other than the web browsers. To use the Internet services provided by the server 30, the user of the terminal device 10 may typically log in to the server 30 through a web browser or an application other than the web browser. More specifically, a user ID and password corresponding to a Internet service which the user is going to use may be transmitted to the server 30 through the web browser or the application other than the web browser, and an authentication process using the user ID and password received from the user may be performed at the server 30.

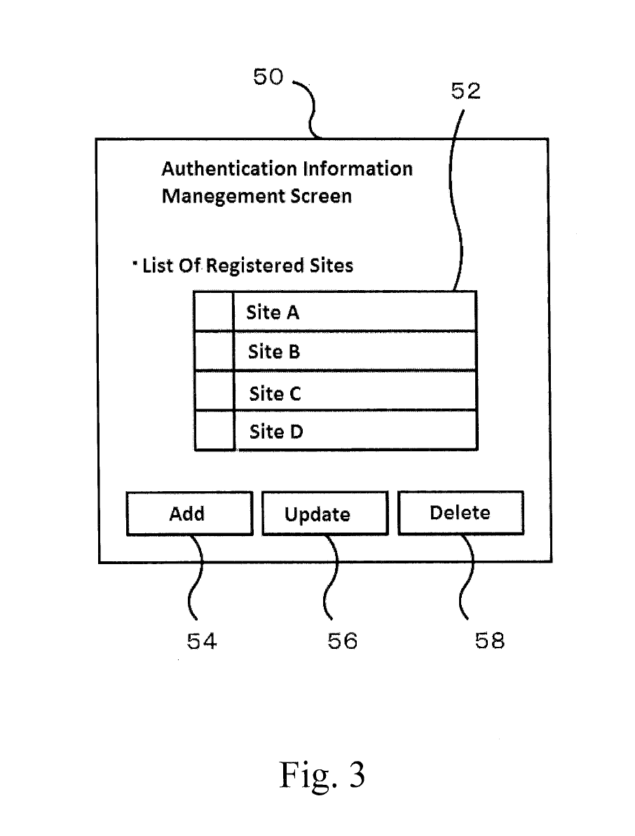

Next, an operation of the terminal device 10 according to an embodiment will be described An operation to manage authentication information for each legitimate site will be firstly described and a login alert operation to warn logins to illegitimate sites based on the authentication information for each legitimate site will be then described. FIG. 3 illustrates an example of an authentication information management screen 50 to manage the authentication information for each legitimate site according to an embodiment. The authentication information management screen 50 may be displayed on the terminal device 10 in response to execution of the login alert program 40 (the authentication information management module 41) on the terminal device 10 by the user. As shown in FIG. 3, the authentication information management screen 50 may include a registered-site list display region 52 where a list of names (site names) of sites of which authentication information is registered is displayed, an add button 54 for registering (adding) new authentication information for sites, an update button for correcting (updating) the authentication information for each site that has been registered, and a delete button 58 for deleting the authentication information for each site that has been registered.

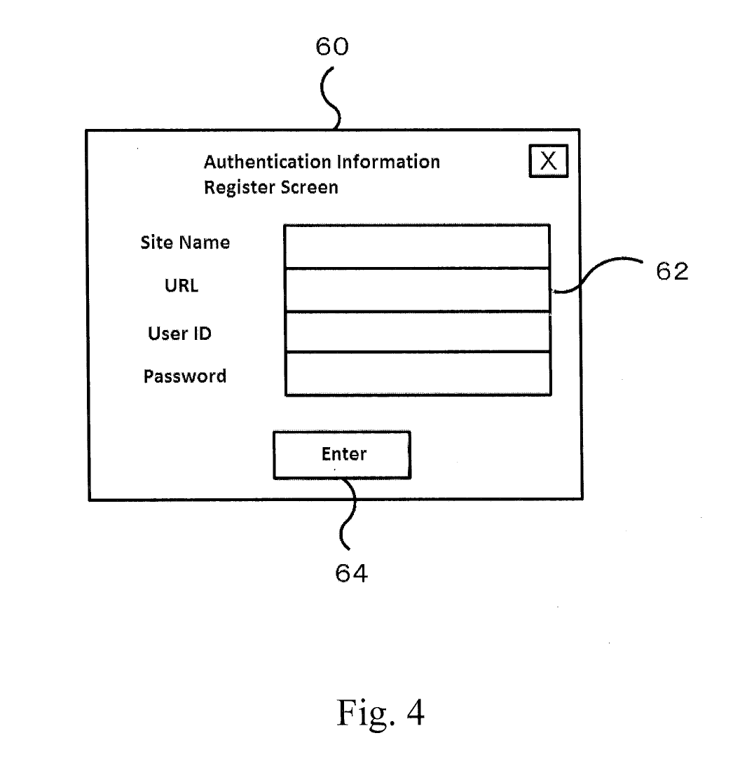

When a user selected the add button 54 on the authentication information management screen 50, an authentication information register screen 60 illustrated in FIG. 4 may be overlaid on the authentication information management screen 50. Referring to FIG. 4, the authentication information register screen 60 may include an authentication information input region 62 and an enter button 64 for confirming the authentication information for each site to be registered. The authentication information input region 62 may be configured to allow user to input a name of a site to which the user wish to connect, a URL (domain name) of the site, a user ID (user identification information) used for login to the site, and a password to log in to the site. Here, the site name may be any name with which the user can recognize the site, and a user may be able to input a desired name (for example, the name of the Internet service corresponding to the site). Once the user selects the enter button 64 after the information is input in the authentication information input region 62, the information input in the authentication information input region 62 may be stored in the authentication information storage area 45 in the above-described storage 15.

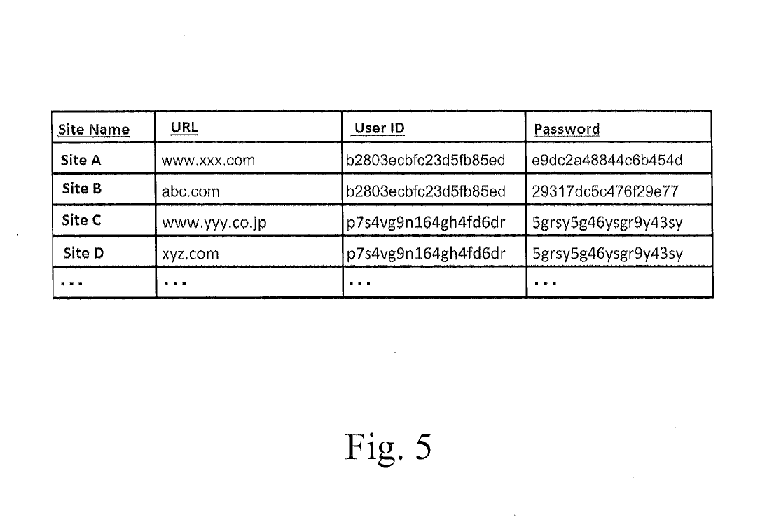

FIG. 5 illustrates specific examples of the authentication information for each site stored in the authentication information storage area 45. In the authentication information storage area 45, the information input in the authentication information input region 62 on the authentication information register screen 60 may be stored. More specifically, as illustrated in FIG. 5, the site name, the URL (domain name), the user ID, and the password may be stored. In other words, the authentication information storage area 45 may store the authentication information used for login to legitimate sites in association with the sites.

In one embodiment, among the information stored in the authentication information storage area 45, the authentication information (the user ID and the password) may be stored as an irreversibly converted authentication information onto which a predetermined irreversible conversion process has been performed. One example of such an irreversible conversion process for information may include a conversion process using a one-way hash function. The process to execute the predetermined conversion process onto the authentication information may be realized by a function of the authentication information management module 41 of the login alert program 40. When the authentication information is irreversibly converted and then stored in the authentication information storage area 45, it is possible to enhance the security of the authentication information.

Referring again to FIG. 3, when a user selected a desired site from among the sites listed in the registered-site list display region 52 on the authentication information management screen 50 and then pressed the update button 56, the above-described authentication information register screen 60 may be overlaid in the same manner as when the add button 54 is selected. The information about the selected site stored in the authentication information storage area 45 may be then displayed on the authentication information input region 62 as default. Once a user selects the enter button 64 after the user corrects the information shown in the authentication information input region 62, the information (the corrected information) input in the authentication information input region 62 may be stored (overwritten) in the authentication information storage area 45.

Moreover, once a user selects the delete button 58 after the user selects a desired site from among the sites listed in the registered-site list display region 52 on the authentication information management screen 50, the information related to the selected site may be deleted from the authentication information storage area 45.

In this manner, a user may be able to register the authentication information for each legitimate site in advance through the authentication information management screen 50 and the authentication information register screen 60 by executing the login alert program 40 (the authentication information management module 41) on the terminal device 10. In another embodiment, the above-described management of the authentication information for each site may be realized by cooperation between the login alert program 40 (the authentication information management module 41) and other application including a web browser. More specifically, when a user logs in to the server 30 through various applications including a web browser, a screen corresponding to the above-described authentication information register screen 60 may be displayed (at this point, the URL (domain name) of a destination site which the user logs in to and the authentication information used for the login may be displayed in a region corresponding to the authentication information input region 62 as default) by the function of the login alert program 40 (the authentication information management module 41), and the user may allow to register authentication information for each site. More specifically, when a user performs user registration to an Internet service provided by the server 30 through various applications, a screen corresponding to the above-described authentication information register screen 60 may be displayed (at this point, the URL (domain name) of a site that provides the Internet service and the authentication information set at the time of the user registration may be displayed in a region corresponding to the authentication information input region 62 as default) by the function of the login alert program 40 (the authentication information management module 41), and the user may allow to register authentication information for each site. The cooperation between the login alert program 40 (the authentication information management module 41) and other application may be realized by, for example, monitoring or detecting login or user registration through other application by the login alert program 40, or activating the login alert program 40 by an application in response to login or user registration through the application,

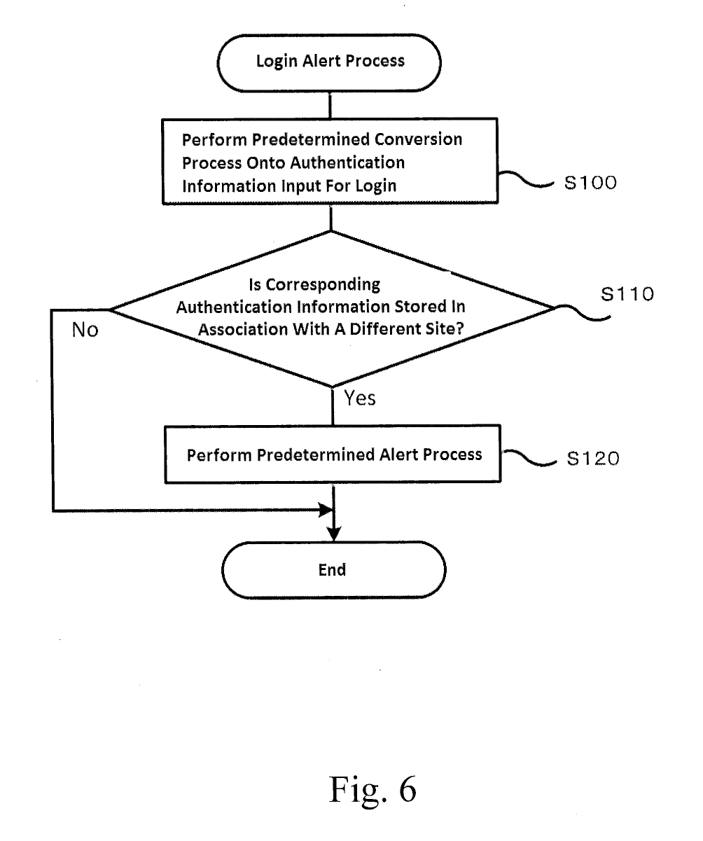

The operation to manage the authentication information for each legitimate site has been described. An operation to alert logins to illegitimate sites based on the authentication information for each legitimate site will be now described. FIG. 6 is a flow diagram showing an example of a login process performed by the terminal device 10 in an embodiment. The login alert process may be performed when a user of the terminal device 10 logs in to the various servers 30 (sites) via various applications including a web browser. More specifically, the login alert process may be performed before authentication information input for login is transmitted to a destination site which the user tries to log in to. The timing before the transmission of the inputted authentication information may include a timing when a user instructs the transmission of the authentication information through an application (for example, when the user selects a button or region for instructing login on a screen of the application), a timing when the user inputs the authentication information through an application (for instance, a timing when the input of the authentication information by the user is determined to be completed, such that a certain time period has elapsed (for instance, 1 second) since the user stopped the input of the authentication information) and the like.

The timing when a user of the terminal device 10 logs in to the server 30 may include a timing of automatic login performed by an application in addition to the timing when the user explicitly instructs login. In this case, the authentication information input for the login may be automatically input by the application.

As described above, at the timing when a user of the terminal device 10 logs in to various servers 30 (sites), the login alert process illustrated by FIG. 6 may be performed by the login alert program 40 in cooperation with various applications including a web browser (for example, the login alert program 40 monitors and detects logins through various applications or the login alert program 40 is activated in response to logins to the various applications). Referring to FIG. 6, in the login alert process, a predetermined conversion process may be firstly performed on authentication information input for login to a destination site (step S100). This process may be realized by a function of the determination module 42 of the login alert program 40. More specifically, a conversion process same as the one performed on the authentication information stored in the authentication information storage area 45 (for example, a conversion process using a one-way hash function) may be performed on the authentication information input for the login.

Subsequently it may be determined whether authentication information corresponding to the authentication information on which the predetermined conversion process has been performed (converted authentication information) is stored in the authentication information storage area 45 in association with a site different from the site on which the login using the input authentication information is performed (step S110), This process may be realized by a function of the determination module 42 of the login alert program 40. More specifically, when the authentication information corresponding to the authentication information input by the user is identified from among the authentication information for each site stored in the authentication information storage area 45 (in other words, when the corresponding authentication information is found in the authentication information storage area 45), it is determined whether the site associated with the identified authentication information is different from the destination site which the user tries to log in to,

The “corresponding authentication information” corresponding to the authentication information input by the user may include various definitions in one embodiment. For example, authentication information including the same user ID and password as those input by the user may be defined as the “corresponding” authentication information, or authentication information including a user ID identical or similar to the one input by the user and the same password as the one input by the user may be defined as the “corresponding” authentication information. Here, the “user ID similar to the user ID input” by the user may be specified based on a degree of similarity among user IDs. For example, a conventional algorithm used to determine a degree of similarity in strings of letters (for instance, Levenshtein distance or the like) may be applied The reason why the authentication information including a user ID similar to the user ID input by the user may be specified as the corresponding authentication information, in addition to the authentication information including the same user ID as the user ID input by the user is stated below. Some phishing sites may have a feature to automatically convert user IDs (for instance, adding a predetermined letter string to a user ID) and when the user ID input by a user is automatically converted by the feature, the user ID identical to the user ID input by the user before the conversion will turn to be different from the user ID after the conversion. Thus, by defining the authentication information including a user ID similar to the user ID input by the user as the corresponding authentication information, as long as the user ID identical to the user ID before the conversion is identified as a user ID similar to the user ID after the conversion, it is possible to identify the authentication information including the user ID identical to the user ID before the conversion as the corresponding authentication information even when a user tries to log in to the phishing sites having the feature that automatically converts the user ID.

When it is determined that the authentication information corresponding to the authentication information input by the user is stored in the authentication information storage area 45 in association with a site different from the site which the user tries to log in to, a predetermined alert process may be performed (step S120). The login alert process is then completed. The execution of the predetermined alert process may be realized by a function of the alert process execution module 43 of the login alert program 40.

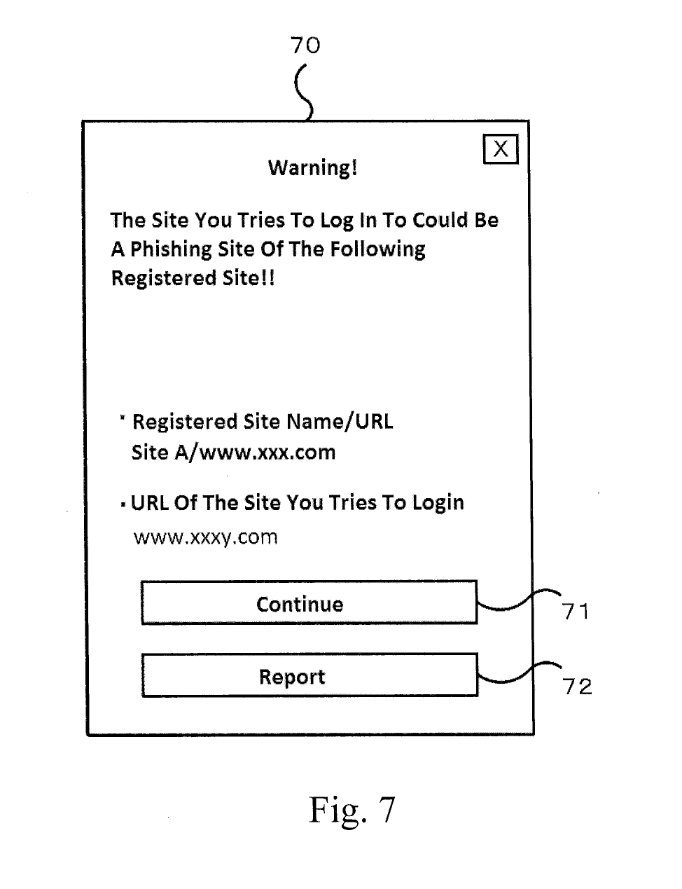

In one embodiment, the predetermined alert process may include various processes to warn logins to illegitimate sites. For instance, a process to display a login alert screen on the terminal device 10 (in other words, the display device of the user who inputs the authentication information) to warn the login may be applied as the predetermined alert process. FIG. 7 illustrates an example of a login alert screen 70 displayed on the terminal device 10 according to an embodiment. Referring to FIG. 7, the login alert screen 70 may include information notifying that a site which a user tries to log in may be a phishing site, information about a registered legitimate site, and information about a destination site which the user tries to log in to. For instance, in the example of FIG. 7, a user may know from the screen that the site “URL: www.xxxy.com” may be a phishing site that looks like the legitimate site “site name: site A, URL: www.xxx.com” stored in the authentication information storage area 45.

Referring to FIG. 7, the login alert screen 70 according to the embodiment may include a continue button 71 for continuing a login process using the authentication information input by a user, and a report button 72 for reporting information about the site where the user tries to log in to a prescribed device. Once a user selects the continue button 71, the login process to log in to a destination site using the authentication information input by the user may be continued and the authentication information may be transmitted to the destination site. For instance, when the user checks the information about the site to which the user tries to log in (for example, the URL) displayed on the login alert screen 70 and determined that the site is not a phishing site, the user may select the continue button 71 to continue the login process.

Whereas once the user selects the report button 72, the information about the site to which the user tries to log in (for example, the URL) may be transmitted to a predetermined device. The predetermined device to which the information is transmitted may include a server associated to the legitimate site, a server of an organization that manages phishing sites or the like. By transmitting, to a predetermined device, the information about the site to which the user tries to log in, it is possible to provide concerned parties related to the legitimate site (for example, a provider of the Internet service) or organizations that manage phishing sites and the like with information about suspicious sites which could be phishing sites and the like. In one embodiment, once a user selects the report button 72, the login process using the authentication information input by the user may be aborted. More specifically, cancellation of the transmission of the authentication information may be instructed to an application including a web browser that transmits the authentication information to the destination site.

Here, a case where the same authentication information (user ID and password) is used as authentication information for more than one legitimate sites will be now considered For example, the same user ID and password is set for the destination site the “site C” and the “site D” as the authentication information. In one embodiment, for example, when a user of the terminal device 10 tries to log in to the “site C,” the authentication information associated with the “site C” is identical to the authentication information associated with the “site D” but the URL is different from each other so it may be determined that the “site C” to which the user tries to log in is likely a phishing site spoofing the “site D” that is registered as a legitimate site, and the above-described predetermined alert process may be performed (for example, the login alert screen 70 is displayed). In this example, instead of the notification telling that the site to which the user tries to log in may be a phishing site, the fact that the authentication information input by the user is identical to the authentication information used for login to other legitimate site may be notified on the login alert screen 70. This is because even when the site to which the user tries to log in is a registered legitimate site, use of the same authentication information for more than one legitimate site increases the risk of unauthorized logins such as a “list-type attack.” Therefore, it may be beneficial to notify a user that the authentication information input by the user is identical to the authentication information used for login to other legitimate site. In this case, the login process using the authentication information input by the user may be automatically continued.

In another embodiment, the above-described predetermined alert process may not be performed when the site to which a user tries to log in is stored as a legitimate site in the authentication information storage area 45.

The terminal device 10 according to the above-described embodiment may store the authentication information that is used for login to a site in the storage 15 (the authentication information storage area 45) in association with the site, and determine whether authentication information corresponding to the authentication information input by a user when the user tries to log in to a destination site is stored in the storage 15 in association with a site different from the destination site. The terminal device 10 may perform the predetermined alert process in response to the determination that the corresponding authentication information is stored in association with the different site. Since authentication information is stored in advance in association with each legitimate site, it is possible to perform the alert process when authentication information is input to log in to illegitimate sites. Consequently, it is possible to prevent logins to illegitimate sites such as phishing sites.

In the above-described embodiment, among the information stored in the authentication information storage area 45, the authentication information (user ID and password) is stored as the converted authentication information to which a prescribed conversion process irreversibly converting the information has been performed onto the authentication information. However, the authentication information may be stored without performing the predetermined conversion process. In this case, the step S100 where the login alert process illustrated in FIG. 6 is performed (the process to perform the predetermined conversion process onto the authentication information input by the user) may not be necessary.

In the above-described embodiment, the storage 15 of the terminal device 10 has the authentication information storage area 45 where the authentication information for each legitimate site is managed. However, the area where the authentication information for each legitimate site is managed may be provided in a device other than the terminal device 10. For instance, the area where the authentication information for each legitimate site is managed may be provided in the server 30 that is managed by a party related to a legitimate site (for instance, an Internet service provider corresponding to the legitimate site) or the server that is managed by an organization managing phishing sites and the like. In this manner, the system according to one embodiment of the disclosure may be configured from the terminal device 10 alone or from the terminal device 10 and one or more servers 30.

Furthermore, in another example where the system according to the embodiment is configured from the terminal device 10 and one or more servers 30, a part or all of the functions of the login alert program 40 may be realized by the server 30 (CPU 31) or realized by cooperation between the terminal device 10 (CPU 11) and the server 30 (CPU 31).

The processes and procedures described and illustrated herein may also be implemented by software, hardware, or any combination thereof other than those explicitly stated for the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

What is claimed is:

1. A computer-readable storage medium storing a program for raising alert over login to illegitimate sites, wherein
in response to execution of the program on a computer accessible to a storage device that stores, for each of one or more sites, authentication information used for login to the site in association with the site, the computer is caused to perform:
determining whether authentication information corresponding to authentication information input for login to a destination site is stored in the storage device in association with a site different from the destination site; and
performing a predetermined alert process in response to determination that the corresponding authentication information is stored in association with the different site.

2. The storage medium storing a program of claim 1, wherein the corresponding authentication information is authentication information identical or similar to the authentication information input for login,

3. The storage medium storing a program of claim 1 wherein
the authentication information includes user identification information identifying a user, and a password, and
the corresponding authentication information is authentication information that includes user identification information identical or similar to user identification information included in the authentication information input for login and a password identical to a password included in the authentication information input for login.

4. The storage medium storing a program of claim 1 wherein
the storage device stores the authentication information as a converted authentication information onto which a predetermined conversion process converting information irreversibly has been performed, and
the determining includes performing the predetermined conversion process onto the authentication information input for login, and determining whether the converted authentication information corresponding to the authentication information input for login converted by the predetermined conversion process is stored in association with the different site.

5. The storage medium storing a program of claim 1 wherein the performing the predetermined alert process includes displaying a predetermined alert screen on a display device of a user who inputs the authentication information.

6. The storage medium storing a program of claim 1 wherein the performing the predetermined alert process includes aborting transmission of the authentication information input for login to the destination site.

7. The storage medium storing a program of claim 1 wherein the performing the predetermined alert process includes transmitting information about the destination site to a predetermined device.

8. A method of raising alert over login to illegitimate sites by one or more computers, comprising:
storing authentication information for each of one or more sites in a storage device in association with the site;
determining whether authentication information corresponding to authentication information input for login to a destination site is stored in the storage device in association with a site different from the destination site; and
performing a predetermined alert process in response to determination that the corresponding authentication information is stored in association with the different site.

9. A system for raising alert over login to illegitimate sites, comprising:
a storage device storing authentication information for each of one or more sites in a storage device in association with the site; and
one or more computer processors,
wherein in response to execution of a predetermined instruction, the one or more computer processor performs:
determining whether authentication information corresponding to authentication information input for login to a destination site is stored in the storage device in association with a site different from the destination site, and
performing a predetermined alert process in response to determination that the corresponding authentication information is stored in association with the different site.
